(19) United States
(12) Patent Application Publication
(10) Pub. No.: US 2009/0175268 A1
(43) Pub. Date: Jul. 9, 2009

(54) METHOD, DEVICE AND SYSTEM FOR COMMUNICATION

(75) Inventors: Shin-Shian Li, Taiwan (CN); Wen-Yao Chang, Taiwan (CN)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/299,865

(22) PCT Filed: May 2, 2007
(86) PCT No.: PCT/JP2007/059800

§ 371 Date: Feb. 6, 2009

(30) Foreign Application Priority Data
May 8, 2006 (CN) 200610079477.9

(51) Int. Cl. H04L 12/66

(52) U.S. Cl. 370/352

(57) ABSTRACT

A communication system adapted to be connected to a calling device through the Internet includes a proxy device and a plurality of communication devices. The proxy device receives messages sent from the calling device through the Internet. Each of the communication devices has specific media processing capability, and receives the messages sent by the calling device through the proxy device and the Internet. The proxy device and the communication devices store the media processing capabilities of the communication devices, and upon receipt of a message requesting connection from the calling device, select one of the communication devices with the media processing capability matching that required by the connection according to the media processing capabilities of the communication devices stored therein. The selected communication device sets up a connection with the calling device through the proxy device, or selects another communication device to set up the connection.

### TECHNICAL FIELD

The invention relates to a method, device and system for communication, and more particularly to a method, device and system for home-use communication.

### BACKGROUND ART

Due to the growing popularity of Voice over IP (VoIP) and the simple design of the Session Initiation Protocol (SIP), so long as a network device has SIP user agent (UA) functionality, it can serve as a calling or callee device in an IP telephony communication. Nowadays, there have been several network phones or intelligent household appliances in a modern house, and when there is an incoming call from an outside calling device, every phone or intelligent household appliance in the house may possibly answer the incoming call. Here, it is noted that such call may include, in addition to voice, video or other information, and that not every phone or household appliance in the house is capable of processing such call. Therefore, if one suitable phone or household appliance can be automatically selected to answer the call, it would be a great convenience to today's family life.

Referring to FIGS. 1 and 2, a conventional household communication system includes a proxy device 5 and a plurality of communication devices 6. The communication devices 6 can be any equipment capable of executing SIP functions and processing voice, e.g., a facsimile machine, a cell phone, a personal digital assistant, a computer, an intelligent refrigerator, a television, etc., without being limited to conventional telephones.

The proxy device 5 is connected to an external network, e.g., the Internet, and the communication devices 6 are electrically connected to the proxy device 5 through a home intranet. An external calling device 7 establishes a connection with the proxy device 5 through the external network. The communication devices 6 communicate with the calling device 7 through the proxy device 5. Transmission of signals between the proxy device 5 and the calling device 7 or the communication devices 6 are based on SIP. Connection control messages defined in SIP include REGISTER, INVITE, ACK, CANCEL, BYE, OPTIONS, and relevant responses, such as OK. Some SIP connection control messages, such as INVITE, OK or ACK, include a Session Description Protocol (SDP) packet, and the SDP packet contains a description of the types of media, such as voice, video, or data, used by the communication device 6 or the calling device 7 in the communication.

Each of the communication devices 6 located at home must be first registered with the proxy device 5. The method of registration includes two steps:

The first step is that each communication device 6 sends a REGISTER message to the proxy device 5.

The second step is that the proxy device 5, after receiving the REGISTER message, sends an OK message to the communication device 6 requesting the registration so that the communication device 6 knows that it has successfully registered.

After all the communication devices 6 at home have completed registration, the method of establishing connections between the external calling device 7 and the communication devices 6 at home includes the following steps:

In step 901, the calling device 7 sends an INVITE message to the proxy device 5, and the INVITE message includes an SDP packet. This is because only the proxy device 5 has a SIP identity that can be identified on the external network, and the communication devices 6 at home do not. This method can save external registration fees.

In step 902, after the proxy device 5 receives the INVITE message, the proxy device 5 forwards the INVITE message to one of the communication devices 6.

In step 903, according to the SDP included in the INVITE message, the communication device 6 receiving the INVITE message checks whether the media processing capability thereof may satisfy the media required in the INVITE message (by the calling device 7). If yes, this indicates that a connection can be established between the calling device 7 and the communication device 6. The flow then goes to step 904. Otherwise, the flow skips to step 908.

In step 904, the communication device 6 returns an OK message including an SDP packet thereof to the proxy device 5. The flow then goes to step 905.

In step 905, the proxy device 5 receives the OK message, and forwards the OK message to the calling device 7. The flow then goes to step 906.

In step 906, the calling device 7 sends an ACK message to the proxy device 5 after receiving the OK message. The flow then goes to step 907.

In step 907, the proxy device 5 forwards the ACK message to the communication device 6. This indicates that the calling device 7 and the communication device 6 can start communication through the proxy device 5 at this juncture.

In step 908, the communication device 6 returns a connection control message indicating a connection failure to the proxy device 5. The flow then goes to step 909.

In step 909, the proxy device 5 forwards the INVITE message to another communication device 6, which causes the latter to execute step 903.

In the conventional communication system, since the proxy device 5 is not aware of the media processing capability that the communication devices 6 have, when the proxy device 5 receives an INVITE message from the calling device 7, it is unable to determine which communication device 6 is most suitable for processing the call according to the SDP in the INVITE message. Therefore, the proxy device 5 must try one by one until the most suitable communication device 6 is located. On the other hand, the proxy device 5 may also find that none of the communication devices 6 is suitable after trying all of them, which is very time-consuming.

In addition, call transfers must be conducted through the proxy device 5 in the conventional communication system, and none of the communication devices 6 has call transfer functions in general. Thus, the proxy device 5 needs to be responsible for many signal transmission tasks.

### DISCLOSURE OF INVENTION

Therefore, the first object of the present invention is to provide a communication system that can quickly determine whether or not to set up a communication connection with a calling device is possible.

Therefore, the second object of the present invention is to provide a communication device that has call transfer functions.

Therefore, the third object of the present invention is to provide a proxy device. The proxy device is aware of the media processing capability of communication devices connected thereto.

Therefore, the fourth object of the present invention is to provide a communication method which, according to the media processing capability required by a connection, selects a communication device with media processing capability matching that required by the connection.

Therefore, the communication system of the present invention is adapted to be connected to a calling device through the Internet, where the communication system includes a plurality of communication devices and a proxy device.

Each of the communication devices has its specific media processing capability. The proxy device is electrically connected to the communication devices, and upon receipt of a message requesting connection from the calling device, selects one of the communication devices which has media processing capability matching that required by the connection according to the media processing capabilities of the communication devices stored in the proxy device. The selected communication device sets up a connection with the calling device through the proxy device.

Accordingly, the method employed by the proxy device and the communication devices of the present invention includes the following steps:

(A) the communication devices registering with the proxy device, and the proxy device storing the media processing capabilities of all the communication devices;

(B) the proxy device selecting one communication device with matched media processing capability according to the media processing capability required by the connection upon receipt of a message requesting connection from the calling device; and

(C) the selected communication device setting up a connection with the calling device through the proxy device.

Accordingly, the communication device of the present invention includes a first user interface, a first network interface, a first connection control unit, a first media processing unit, and a first feature control unit.

Accordingly, the proxy device of the present invention includes a second user interface, a second network interface, a second connection control unit, and a second feature control unit.

The first user interface receives and stores the attributes of the communication device inputted by the user. The first network interface is electrically connected to the proxy device through an internal network. The first connection control unit can send and receive messages through the first network interface so as to communicate with the proxy device. The first media processing unit stores its media processing capability and can process received media.

The first feature control unit receives and processes the messages sent from the first connection control unit, organizes the media processing capability stored in the first media processing unit and the attributes stored in the first user interface into equipment feature data of the communication device, transmits the equipment feature data to the proxy device through the first network interface so as to register with the proxy device, and receives and stores a communication list transmitted from the proxy device.

If the first media processing unit is capable of processing the media required by the connection sent from the calling device through the proxy device, the first connection control unit can be connected to the proxy device through the first network interface so as to set up a connection with the calling device through the proxy device.

If the first media processing unit is incapable of processing the media required by the connection, the first feature control unit can, according to the communication list stored therein, transfer the connection to another communication device capable of processing the required media.

The second user interface receives and stores the transfer rules set by the user so as to define an order of priority of the communication devices to process the connection. The second network interface is electrically connected to the communication devices through the internal network, and is electrically connected to the calling device through an external network. The second connection control unit can send and receive messages through the second network interface so as to communicate with the communication devices and the calling device.

The second feature control unit receives and processes the messages sent from the second connection control unit, further receives the equipment feature data of each communication device, organizes all the equipment feature data into a communication list, arranges the communication devices recorded in the communication list according to the transfer rules stored in the second user interface, and stores the communication list thus arranged and sends the same to each communication device.

The second feature control unit selects a communication device capable of processing the connection from the communication list upon receipt of a message requesting connection from the calling device, thereby enabling the proxy device to serve as a connection intermediary between the calling device and the selected communication device.

### BRIEF DESCRIPTION OF DRAWINGS

Other features and advantages of the present invention will become apparent in the following detailed description of the preferred embodiment with reference to the accompanying drawings, of which:

FIG. 1 is a schematic diagram to illustrate a connection between a conventional communication system including a proxy device and a plurality of communication devices, and an external calling device;

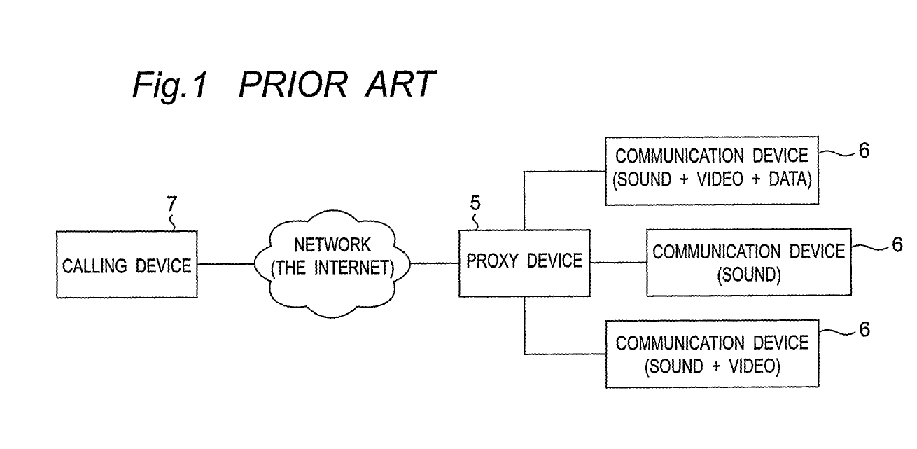

FIG. 2 is a flowchart to illustrate the process of establishing the connection between the conventional communication system and the calling device;

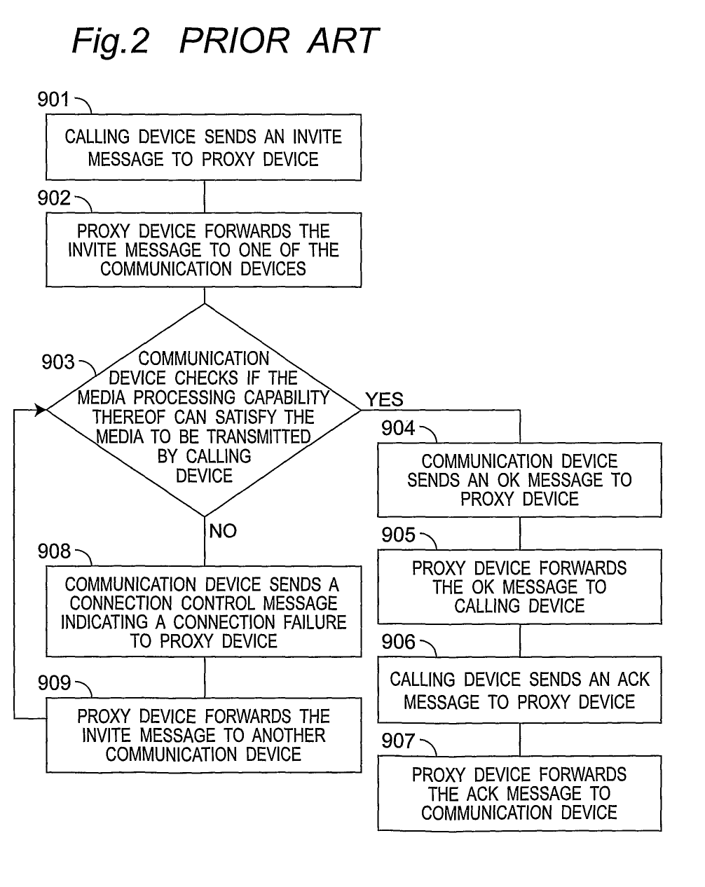

FIG. 3 is a circuit block diagram to illustrate a proxy device and a plurality of communication devices in the first preferred embodiment of a communication system according to the present invention;

FIG. 4 shows a communication list stored in a second feature control unit;

FIG. 5 is a flowchart of a communication method employed by the first preferred embodiment of the communication system according to the present invention;

FIG. 6 is a sequence diagram of the first preferred embodiment of the communication system according to the present invention, illustrating the setup of communication between the communication system and a calling device in the event that the user has not preset any default communication device to answer incoming calls; and

FIG. 7 is a sequence diagram of the first preferred embodiment of the communication system according to the present invention, illustrating the setup of communication between the communication system and the calling device in the event that the user has preset a default communication device to answer incoming calls.

### BEST MODE FOR CARRYING OUT THE INVENTION

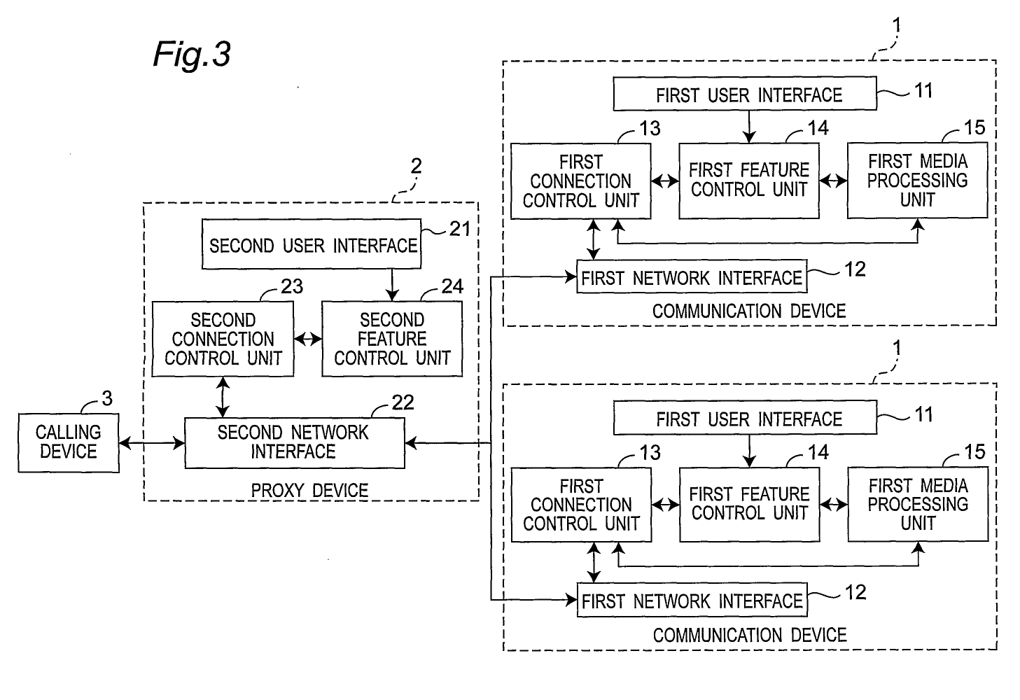

Referring to FIG. 3, the first preferred embodiment of a communication system according to the present invention includes a plurality of communication devices 1 and a proxy device 2. In this embodiment, the proxy device 2 and the communication devices 1 are installed in a house, and may be placed in different rooms depending on use conditions, without limiting the invention thereto, and may also be installed in an office environment.

Each device 1 may be a network phone or may be added to an existing phone, such as a cell phone and a facsimile machine, to enable its IP telephony. In addition, each communication device 1 may also be a computer, an intelligent household appliance, or may be added to an existing intelligent household appliance to couple therewith, where the intelligent household appliance may be a refrigerator capable of playing video and voice, or a television. However, the communication devices 1 of the present invention are not limited to the aforesaid, and may be any equipment capable of executing SIP functions.

Each communication device 1 includes a first user interface 11, a first network interface 12, a first connection control unit 13, a first feature control unit 14, and a first media processing unit 15. The proxy device 2 includes a second user interface 21, a second network interface 22, a second connection control unit 23, and a second feature control unit 24.

The first user interface 11 of each communication device 1 stores the attributes of the respective communication device 1. The attributes are inputted into the first user interface 11 by the user, and may include the location (e.g., living room, kitchen, etc.) of the respective communication device 1, the extension number of the respective communication device 1, and the credit given to the respective communication device 1 by the user. The credit represents whether the user would prefer to use the respective communication device 1 to answer incoming calls. For example, if the user often stays in the living room, he/she may give a higher credit to the communication device 1 located in the living room.

The second user interface 21 of the proxy device 2 may receive and store the transfer rules set by the user so as to define an order of priority of the communication devices 1 to answer an incoming call. For instance, the rules may be set in such a way that when a plurality of the communication devices 1 have the capability to answer the call, the communication device 1 with the highest credit will have the priority to answer the call, or that the communication device 1 with the smallest extension number will have the priority to answer. In addition, the transfer rules may also specify a default communication device 1 so that it has the priority to answer each call.

The second network interface 22 of the proxy device 2 is connected to the first network interfaces 12 of the communication devices 1 through a home intranet. The intranet may be a wireless network or a wired network. In addition, the second network interface 22 of the proxy device 2 is also connected to an external network, and utilizes the external network to connect with a calling device 3.

The second connection control unit 23 of the proxy device 2 may receive connection control messages from the communication devices 1 or the external calling device 3 through the second network interface 22. In this embodiment, the connection control messages include, but are not limited to, SIP-defined connection control messages. The SIP connection control messages are, e.g., REGISTER, INVITE, OK, and REFER. Some of the SIP connection control messages will include an SDP packet. The SDP packet records media requirement in a connection or processing capability of the device sending the control message (e.g., the calling device 3 or communication device 1), i.e., specific types of voice, video or data.

The first connection control unit 13 of each communication device 1 is similar to the second connection control unit 23 of the proxy device 2, and is therefore not described in detail herein for the sake of brevity.

The first media processing unit 15 of each communication device 1 stores the media processing capability of the respective communication device 1, e.g., the media which the communication device 1 can process include only voice, the media which the communication device 1 can process include voice and video, or the media which the communication device 1 can process include voice, video and data. Besides, when the first media processing unit 15 of each communication device 1 receives media transmitted from the outside, it can perform suitable processing thereof.

The first feature control unit 14 of each communication device 1 organizes the media processing capability stored in the first media processing unit 15 and the attributes stored in the first user interface 11 into equipment feature data of the respective communication device 1.

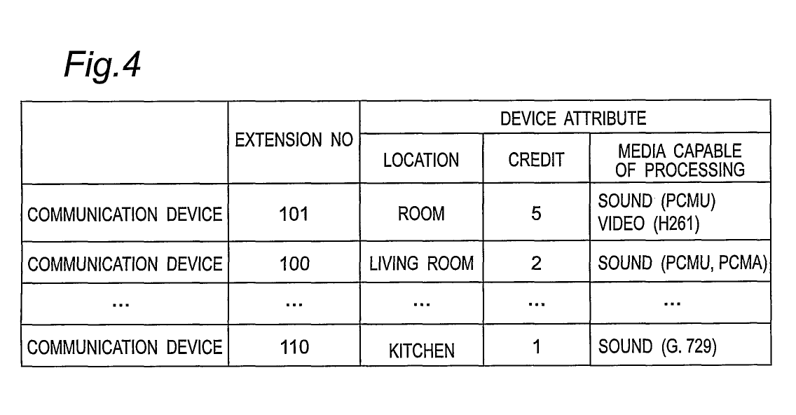

The second feature control unit 24 of the proxy device 2 receives the equipment feature data of each communication device 1 through the second network interface 22, organizes the equipment feature data into a communication list for storage, and according to the transfer rules (e.g., the one with a higher credit has a higher priority) stored in the second user interface 21, arranges the order of the communication devices 1 as recorded in the communication list (as shown in FIG. 4).

In addition, the second feature control unit 24 of the proxy device 2 can also send the arranged communication list to each communication device 1 through the second network interface 22 for storage in the first feature control unit 14 of each communication device 1. Both the first and the second feature control units 14, 24 can compare the media processing requirement of an incoming call with the media processing capabilities recorded in the communication list so as to find the communication device 1 which is capable of processing the incoming call.

In addition, the second feature control unit 24 of the proxy device 2 can further update the credits recorded in the communication list according to whether the communication devices 1 have successfully processed connections. For example, if a certain communication device 1 successfully established a connection, its credit will be increased by 1.

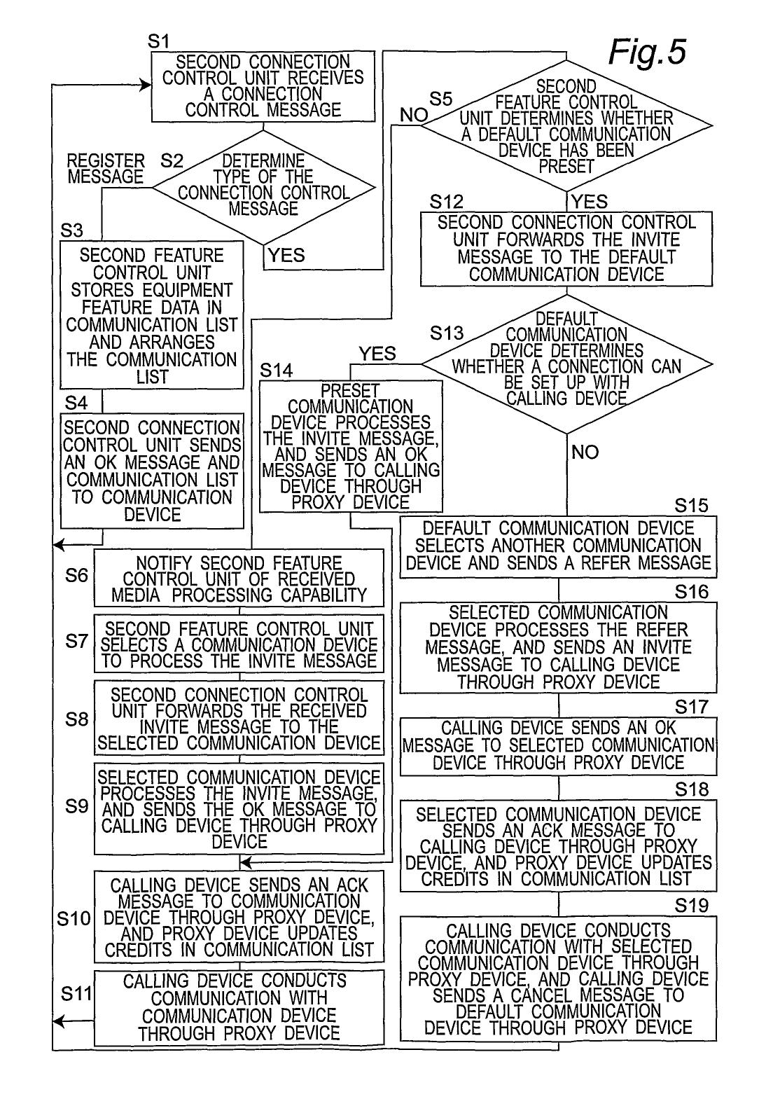

Referring to FIGS. 3 to 5, the communication method employed by the communication system according to the present invention includes the following steps:

In step S1, the second connection control unit 23 of the proxy device 2 receives a connection control message through the second network interface 22.

In step S2, the second connection control unit 23 of the proxy device 2 determines the type of the connection control message. If the connection control message is a REGISTER message sent from the other communication devices 1, step S3 is executed. If it is an INVITE message sent from the external calling device 3, the flow skips to step S5.

In step S3, the second connection control unit 23 of the proxy device 2 sends the REGISTER message to the second feature control unit 24. The second feature control unit 24 stores the equipment feature data described by SDP in the REGISTER message into the communication list, and arranges the corresponding communication device 1 in a suitable position of the communication list.

In step S4, the second feature control unit 24 of the proxy device 2 notifies the second connection control unit 23 to send an OK message to the corresponding communication device 1 to indicate its successful registration and simultaneously sends the communication list as currently arranged to the corresponding communication device 1. The flow then returns to step S1.

In step S5, the second feature control unit 24 of the proxy device 2 determines whether the second user interface 21 has preset a default communication device 1. If no, step S6 is executed. Otherwise, step S12 is executed.

In step S6, the second connection control unit 23 of the proxy device 2 inspects the SDP in the INVITE message to inquire about the media processing requirement of the calling device 3, and to notify the second feature control unit 24 of the proxy device 2 of the media processing requirement. Step S7 is then executed.

In step S7, the second feature control unit 24 of the proxy device 2 selects one communication device 1 according to the media processing capability of each communication device 1 in the communication list to process the INVITE message (if a number of the communication devices 1 are capable of processing the connection, select one according to the order in the communication list), and notifies the second connection control unit 23 of the proxy device 2 of the selection result.

In step S8, the second connection control unit 23 of the proxy device 2 forwards the received INVITE message to the selected communication device 1. The flow then goes to step S9.

In step S9, the first connection control unit 13 of the selected communication device 1 processes the INVITE message, and the first network interface 12 of the selected communication device 1 sends an OK message to the second network interface 22 of the proxy device 2. The second network interface 22 of the proxy device 2 sends the OK message to the calling device 3.

In step S10, the calling device 3 sends an ACK message to the second network interface 22 of the proxy device 2. The second network interface 22 of the proxy device 2 forwards the ACK message to the selected communication device 1. The second feature control unit 24 will update the credits recorded in the communication list thereof, e.g., increasing the credit of the communication device 1 that successfully sets up the connection.

In step S11, the calling device 3 conducts a communication with the communication device 1 through the proxy device 2, where simultaneous data transmission is possible. The received media data is processed by the first media processing unit 15 of the communication device 1. The flow returns to step S1 after termination of the connection.

In step S12, the second connection control unit 23 of the proxy device 2 forwards the received INVITE message to the default communication device 1 through the second network interface 22 of the proxy device 2. Step S13 is then executed.

In step S13, the first connection control unit 13 of the default communication device 1 inspects the SDP in the INVITE message to learn of the media processing requirement of the calling device 3, and requests the first feature control unit 14 to determine whether a connection can be set up with the calling device 3 according to the media processing capability of the default communication device 1. If yes, the flow goes to step S14. Otherwise, the flow skips to step S15.

In step S14, the first connection control unit 13 of the default communication device 1 processes the INVITE message, and sends an OK message to the second network interface 22 of the proxy device 2 through the first network interface 12 of the default communication device 1. The second network interface 22 of the proxy device 2 transmits the OK message to the calling device 3. The flow then goes to step S10.

In step S15, the first feature control unit 14 of the default communication device 1 selects one communication device 1 with such media processing capability from the communication list stored therein, and the first connection control unit 13 of the default communication device 1 sends a REFER message to the selected communication device 1. The flow then goes to step S16.

In step S16, the first connection control unit 13 of the selected communication device 1 processes the REFER message, and sends an INVITE message to the proxy device 2 through the first network interface 12 of the selected communication device 1. The second network interface 22 of the proxy device 2 transmits the INVITE message to the calling device 3. The flow then goes to step S17.

In step S17, the calling device 3 sends an OK message to the proxy device 2. The second network interface 22 of the proxy device 2 transmits the OK message to the selected communication device 1. The flow then goes to step S18.

In step S18, the first network interface 12 of the selected communication device 1 sends an ACK message to the proxy device 2. The second network interface 22 of the proxy device 2 transmits the ACK message to the calling device 3, and the second feature control unit 24 of the proxy device 2 updates the credits recorded in the communication list. The flow then goes to step S19.

In step S19, the calling device 3 conducts a communication with the selected communication device 1 through the proxy device 2, where data transmission at the same time is possible. The received media data is processed by the first media processing unit 15 of the selected communication device 1. The calling device 3 sends a CANCEL message to the proxy device 2. The second network interface 22 of the proxy device 2 transmits the CANCEL message to the default communication device 1. The flow then returns to step S1.

Two examples are cited herein to illustrate the above-described process flow.

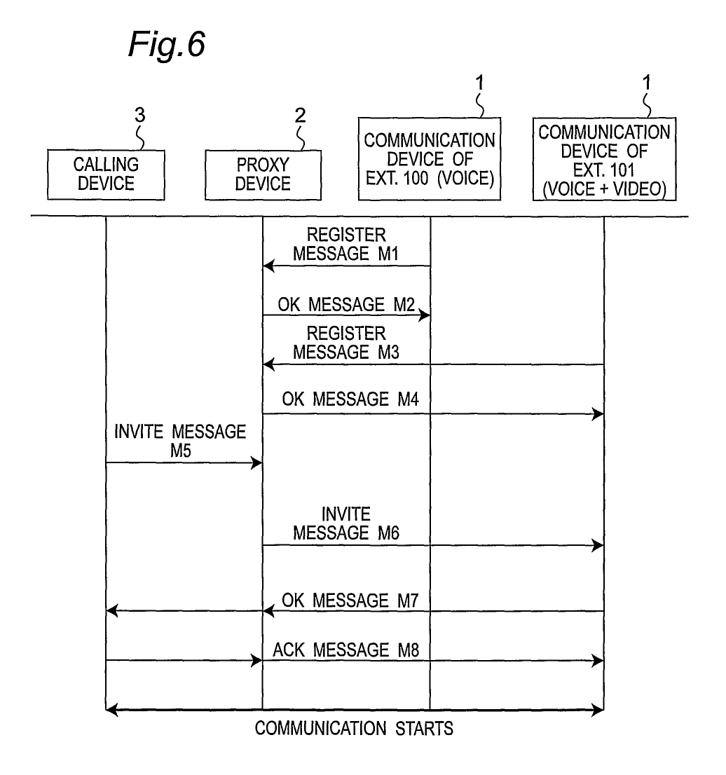

Referring to FIG. 6, it is supposed in the first example that the user has not preset a default communication device 1 to have the priority to answer incoming calls, and that there are two communication devices 1. One communication device 1 is assigned extension 100, which is located in the living room, has a credit 2 given by the user, and is capable of processing voice only. The other communication device 1 is assigned extension 101, which is located in another room, has a credit 5 given by the user, and is capable of processing both voice and video. The results of executing the above process flow are as follows:

According to step S1, the proxy device 2 receives a REGISTER message M1 sent from the communication device 1 of extension 100, and the proxy device 2 sends an OK message M2 to the communication device 1 of extension 100 according to steps S2 to S4 to indicate a completion of registration. Therefore, at this time, the communication lists stored in the proxy device 2 and in the communication device 1 of extension 100 contain only data of the communication device 1 of extension 100.

Subsequently, the proxy device 2 also receives a REGISTER message M3 sent from the communication device 1 of extension 101 according to step S1, and the proxy device 2 sends an OK message M4 to the communication device 1 of extension 101 according to steps S2 to S4. Therefore, at this time, the data of the two communication devices 1 of extensions 100 and 101 will be in the communication lists stored in the proxy device 2 and in the communication device 1 of extension 101. However, the data in the communication list stored in the communication device 1 of extension 100 remains the same (having those of the communication device 1 of extension 100 only) and is yet to be updated. Therefore, there is not any data of extension 101.

Thereafter, according to step S1, the proxy device 2 receives an INVITE message M5 sent from a calling device 3. Since it is supposed that the user has not preset a default communication device 1 in this example, steps S2, and S5 to S7 are executed in sequence. Moreover, in step S7, according to credit ranking, the second feature control unit 24 of the proxy device 2 selects the communication device 1 with a higher credit (i.e., extension 101) to process the INVITE message. Then, according to step S8, the proxy device 2 forwards an INVITE message M6 to the communication device 1 of extension 101. Thereafter, according to step S9, the communication device 1 of extension 101 sends an OK message M7 to the proxy device 2, and the proxy device 2 transmits the OK message M7 to the calling device 3. Then, according to step S10, the proxy device 2 receives an ACK message M8 sent from the calling device 3, the second network interface 22 thereof delivers the ACK message M8 to the communication device 1 of extension 101, and the second feature control unit 24 thereof will add 1 to the credit of the communication device 1 of extension 101 in the communication list stored therein. Furthermore, according to step S11, the calling device 3 conducts a communication with the communication device 1 of extension 101 through the proxy device 2.

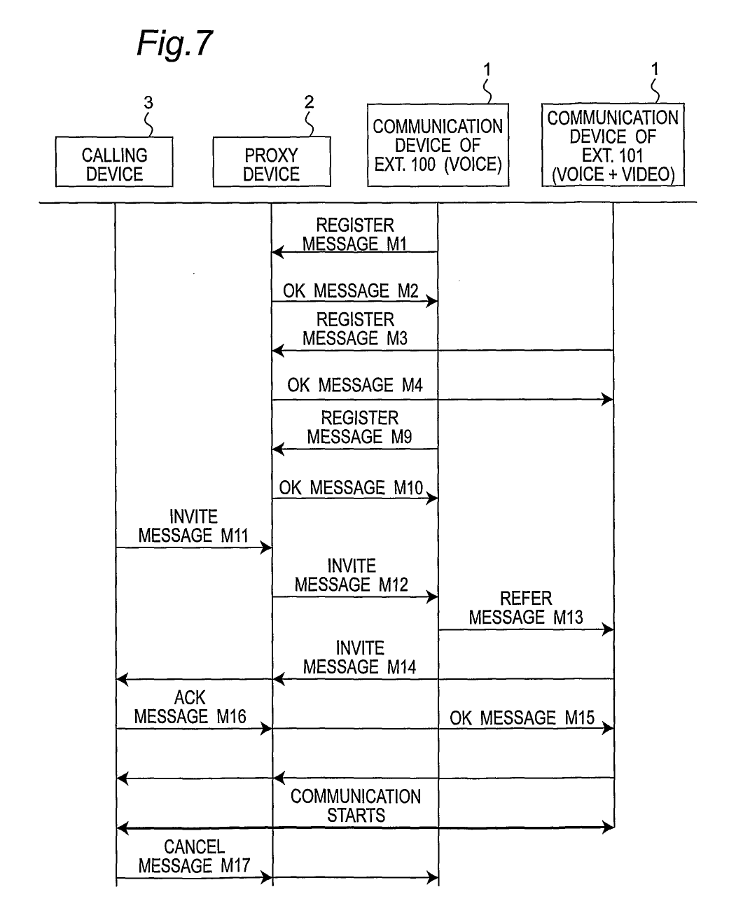

Referring to FIG. 7, it is supposed in the second example that the user has preset the communication device 1 of extension 100 as the default communication device 1 in the second user interface 21 of the proxy device 2.

The messages M1 to M4 and the associated process flow in FIG. 7 are similar to those in FIG. 6, and are therefore not described herein for the sake of brevity.

However, in this example, the communication device 1 of extension 100 will once again send a REGISTER message M9 according to step S1 so as to register with the proxy device 2 anew. Besides, according to steps S2 to S4, the proxy device 2 sends an OK message M10 to the communication device 1 of extension 100, so that the communication device 1 of extension 100 obtains a complete communication list containing its data and those of extension 101.

Thereafter, the calling device 3 sends an INVITE message M11. The proxy device 2 executes steps S1, S2 and S5 in sequence. Besides, since the communication device 1 of extension 100 has been preset as having the processing priority, the proxy device 2 executes step S12, and forwards an INVITE message M12 to the communication device 1 of extension 100. The communication device 1 of extension 100 then executes step S13. In step S13, since the incoming call includes video and voice, and since the communication device 1 of extension 100 merely has the capability to process voice, a connection cannot be set up with the calling device 3. Therefore, the flow skips to step S15. In step S15, the communication device 1 of extension 100 transfers the call to the communication device 1 of extension 101 via a REFER message M13. Then, step S16 is executed. In step S16, the communication device 1 of extension 101 sends an INVITE message M14 to the calling device 3 through the proxy device 2. Then, step 17 is executed, and the proxy device 2 forwards an OK message M15 from the calling device 3 to the communication device 1 of extension 101. Thereafter, according to step S18, the proxy device 2 receives an ACK message M16 from the communication device 1 of extension 101, and transmits the ACK message M16 to the calling device 3. The second feature control unit 24 of the proxy device 2 will add 1 to the credit of the communication device 1 of extension 101 in the communication list stored therein. Thereafter, according to step S19, the calling device 3 conducts a communication with the communication device 1 of extension 101 through the proxy device 2, and the calling device 3 transmits a CANCEL message M17 to the default communication device 1, i.e., the communication device 1 of extension 100, through the proxy device 2, so as to cancel the unfinished INVITE message M11.

In another (the second) preferred embodiment of this invention, the proxy device 2 also has the basic function of answering phone calls. Therefore, aside from including the second user interface 21, the second network interface 22, the second connection control unit 23, the second feature control unit 24, the proxy device 2 further includes a second media processing unit (not shown). Therefore, the proxy device 2 can also execute the functions of the communication device 1, and can conduct a communication with the calling device 3 directly.

In sum, each communication device 1 in the communication system of the present invention has the function of transferring calls. Therefore, in case there is an incoming call that a communication device 1 is unable to answer, there is no need to go back to the proxy device 2 for processing as in the prior art. The call will be automatically transferred, thereby increasing the processing speed. In addition, the proxy device 2 has the attributes and media processing capability of each communication device 1 recorded therein, so that, unlike the prior art, there is no need to inspect the communication devices 1 one by one to find out which communication device 1 is capable of answering the call. The incoming call can be transferred to a suitable communication device 1 in a short amount of time.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A communication method adapted to select one from a plurality of communication devices to process a connection when a proxy device receives a connection request from a calling device, each of the communication devices having a specific media processing capability, the communication method comprising the following steps:
(A) enabling the communication devices to register with the proxy device, and enabling the proxy device to store the media processing capabilities of all the communication devices;
(B) according to the media processing capability required by the connection, enabling the proxy device to select one communication device which has matched media processing capability upon receipt of a message requesting connection from the calling device; and
(C) enabling the selected communication device to set up a connection with the calling device through the proxy device.

2. The communication method according to claim 1, wherein, in step (A), the proxy device further sends the media processing capabilities of all the communication devices stored therein to each of the communication devices, and the method further comprises a step after step (B), in which the selected communication device is enabled to select another suitable communication device to process the connection when the communication device previously selected by the proxy device is unable to process the connection.

3. The communication method according to claim 1, wherein step (A) further includes the following sub-steps:
enabling the proxy device to receive transfer rules set by the user so as to define an order of priority of the communication devices to process the connection;
enabling each of the communication devices to receive and store the attributes thereof inputted by the user, and enabling the proxy device to organize the attributes and media processing capabilities of all the communication devices into a communication list, to arrange the communication devices recorded in the communication list according to the transfer rules, and to store the communication list thus arranged and to send the communication list to each of the communication devices; and
wherein, in step (B): the proxy device is enabled to select a communication device which is capable of processing the connection from the communication list upon receipt of the message requesting connection, the selected communication device transferring the connection to another communication device which is capable of processing the connection according to the communication list stored therein when the selected communication device is unable to process the connection.

4. The communication method according to claim 3, wherein, in step (A), the transfer rules stored in the proxy device includes a default communication device preset by the user, the proxy device first selecting the default communication device to process the connection upon receipt of the message requesting connection from the calling device.

5. The communication method according to claim 3, wherein, in step (A), the attributes of the communication devices include the credits respectively given to the communication devices by the user, the transfer rules stored in the proxy device including arranging the communication devices recorded in the communication list in order of ranking of the credits.

6. The communication method according to claim 1, wherein, in step (B), in case many of the communication devices have the media processing capabilities matching that required by the connection when the proxy device makes the selection, the proxy device selects the communication device which has the highest credit according to the credits given to the communication devices by the user to process the connection.

7. The communication method according to claim 1, further comprising a step after step (C): enabling the proxy device to update the credits of the communication devices according to whether the communication devices have successfully processed connections.

8. The communication method according to claim 1, wherein intercommunication among the communication devices, the proxy device, and the calling device conforms to the Session Initiation Protocol.

9. A communication device adapted to set up a connection with a calling device through a proxy device, said communication device comprising:
a first user interface to receive and store the attributes of said communication device which are inputted by a user;
a first network interface adapted to be electrically connected to the proxy device;
a first connection control unit capable of sending and receiving messages through said first network interface so as to communicate with the proxy device;
a first media processing unit storing its media processing capability and capable of processing received media; and
a first feature control unit which receives and processes the messages transmitted from said first connection control unit, which organizes the media processing capability stored in said first media processing unit and the attributes stored in said first user interface into equipment feature data of said communication device, which is adapted to transmit the equipment feature data to the proxy device through said first network interface so as to register with the proxy device, and which is adapted to receive a communication list transmitted from the proxy device.

10. The communication device according to claim 9, wherein, when said first media processing unit is capable of processing the media required by the connection sent from the calling device through the proxy device, said first connection control unit is capable of connecting with the proxy device through said first network interface so as to be connected to the calling device through the proxy device; and when said first media processing unit is incapable of processing the media required by the connection, said first feature control unit transfers the connection to another communication device capable of processing the required media according to the communication list stored therein.

11. The communication device according to claim 9, wherein the attributes stored in said first user interface include the credits given to said communication device by the user, and the communication list is arranged according to the credit ranking of the communication device.

12. The communication device according to claim 9, wherein the messages sent by said first connection control unit conform to the Session Initiation Protocol.

13. A proxy device adapted to transfer a connection of a calling device to one of a plurality of communication devices, said proxy device comprising:
a second user interface to receive and store the transfer rules set by the user so as to define an order of priority of the communication devices to process the connection;
a second network interface adapted to be electrically connected to the communication devices through an internal network, and adapted to be electrically connected to the calling device through an external network;
a second connection control unit capable of sending and receiving messages through said second network interface so as to communicate with the communication devices and the calling device; and
a second feature control unit which receives and processes the messages sent from said second connection control unit, which receives equipment feature data of each of the communication devices, which organizes all the equipment feature data into a communication list, which arranges the communication devices recorded in the communication list according to the transfer rules stored in said second user interface, and which stores the communication list thus arranged and sends the communication list to each of the communication devices.

14. The proxy device according to claim 13, wherein, when said second feature control unit receives a message requesting connection from the calling device, said second feature control unit selects a communication device which is capable of processing the connection from the communication list, thereby enabling the proxy device to serve as a connection intermediary between the calling device and the selected communication device.

15. The proxy device according to claim 13, wherein the transfer rules stored in said second user interface includes arranging the communication devices recorded in the communication list according to ranking of the credits given to the communication devices by the user.

16. The proxy device according to claim 15, wherein said second feature control unit updates the credits of the communication devices according to whether the communication devices have successfully processed connections.

17. The proxy device according to claim 13, wherein the transfer rules stored in said second user interface includes a default communication device preset by the user, said second feature control unit selecting the default communication device to process the connection upon receipt of the message requesting connection.

18. The proxy device according to claim 13, further comprising a second media processing unit storing its media processing capability and capable of processing received media so that said proxy device can directly process the connection when said second feature control unit determines that the media processing capability stored in said second media processing unit matches that required by the connection upon receipt of the message requesting connection.

19. The proxy device according to claim 13, wherein the messages sent by said second connection control unit conform to the Session Initiation Protocol.

20. A communication system adapted to be connected to a calling device through the Internet, said communication system comprising:
a plurality of communication devices, each of which has a specific media processing capability; and
a proxy device which is electrically connected to said communication devices, which stores the media processing capabilities of said communication devices, and which, upon receipt of a message requesting connection from the calling device, selects one of said communication devices which has the media processing capability matching that required by the connection according to the media processing capabilities of said communication devices stored in said proxy device, said selected communication device setting up a connection with the calling device through said proxy device.

21. The communication system according to claim 20, wherein each of said communication devices has transfer functionality and stores the media processing capabilities of all of said communication devices so that, when said selected communication device by said proxy device is unable to process the connection, said selected communication device will select another suitable communication device to process the connection.

22. The communication system according to claim 20, wherein, in case many of said communication devices have the media processing capabilities matching that required by the connection when said proxy device makes the selection, said proxy device selects one said communication device which has the highest credit according to the credits given to said communication devices by the user to process the connection.

23. The communication system according to claim 22, wherein said proxy device updates the credits of said communication devices according to whether said communication devices have successfully processed connections.

24. The communication system according to claim 20, wherein intercommunication among the communication devices, the proxy device, and the calling device conforms to the Session Initiation Protocol.
